(19) United States
(12) Patent Application Publication
(10) Pub. No.: US 2020/0104811 A1
(43) Pub. Date: Apr. 2, 2020

(54) Enterprise Wide Payment Processing Foundation

(71) Applicant: Alogent Corporation, Peachtree Corners, GA (US)

(72) Inventors: Jason SCHWABLINE, Geneva, FL (US); Ashish BHATIA, Suwanee, GA (US)

(73) Assignee: Alogent Corporation, Peachtree Corners, GA (US)

(21) Appl. No.: 16/588,297

(22) Filed: Sep. 30, 2019

Related U.S. Application Data
(60) Provisional application No. 62/739,435, filed on Oct. 1, 2018.

(51) Int. Cl. G06Q 20/10; G06Q 20/40; G06Q 20/20; G06Q 20/12; G07F 7/10

(52) U.S. Cl. CPC G06Q 20/10; G06Q 20/405; G07F 7/10; G06Q 20/12; G06Q 20/4016; G06Q 20/20

(57) ABSTRACT

A system includes at least one processor and a memory coupled to the at least one processor. The memory stores a database including previous transaction information and a set of business rules and instructions that, upon execution, cause the at least one processor to receive, from a transaction device, transaction information of a transaction and analyze the transaction information. The instructions cause the at least one processor to transmit the transaction information to a payment processing device to process the transaction information. The processing includes analyzing the transaction information based on the set of business rules, in response to the analyzing indicating the transaction is fraudulent, generating and adding a flag to the transaction information, and storing the transaction information in the database as previous transaction information.

### CROSS REFERENCE

This application claims the benefit of U.S. Provisional Application 62/739,435, filed Oct. 1, 2018. The entire disclosure of the above application is incorporated herein by reference.

### FIELD

The present disclosure relates to financial transaction systems, methods, and devices, and, more particularly, to check capture and processing using a single software.

### BACKGROUND

Most systems running in the back offices of financial systems today are very complex with aging legacy solutions, fragmented by, for example, payment type or clearing mechanism and rely on the traditional batch processing mechanism. As financial institutions have grown through acquisitions, they have kept the multiple systems to maintain links to the different clearing and settlement mechanisms resulting in a “spaghetti architecture.” This has resulted in higher infrastructure and support costs, which are difficult to eliminate. Additionally, these systems rely on file transfers to maintain the links. The files used for information transfer between systems have a pre-defined structure that is not amenable to change to include the newer payment types being introduced in the market today. Exchange of files between systems also results in the need to reconcile the work processed in one system versus the other.

The background description provided here is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A system includes at least one processor and a memory coupled to the at least one processor. The memory stores a database including previous transaction information and a set of business rules and instructions that, upon execution, cause the at least one processor to receive, from a transaction device, transaction information of a transaction and analyze the transaction information. The instructions cause the at least one processor to transmit the transaction information to a payment processing device to process the transaction information. The processing includes analyzing the transaction information based on the set of business rules, in response to the analyzing indicating the transaction is fraudulent, generating and adding a flag to the transaction information, and storing the transaction information in the database as previous transaction information.

In other features, the transaction information includes at least one of: (i) an amount, (ii) a payor, (iii) a payee, and (iv) a magnetic ink character recognition line. In other features, the set of business rules include: (i) fraud recognition rules and (ii) duplicate detection rules. In other features, analyzing the transaction information based on the set of business rules includes receiving an indication of fraudulent activity from the payment processing device. In other features, the received indication indicates that transaction parameters of the transaction exceed a known fraud threshold. In other features, based on the received indication, the instructions, upon execution, cause the at least one processor to cancel the transaction associated with transaction parameters of the transaction and generate and transmit a cancellation alert.

In other features, the instructions, upon execution, cause the at least one processor to, in response to the transaction being flagged, store transaction parameters of the transaction in a review database. In other features, the review database is incorporated into the database. In other features, a device associated with an entity can access the review database to manually review transaction parameters of flagged transactions. In other features, the instructions, upon execution, cause the processor to, in response to the analyzing indicating the transaction is not fraudulent, marking the transaction as safe.

A method includes receiving, from a transaction device, transaction information of a transaction, analyzing the transaction information, and transmitting the transaction information to a payment processing device to process the transaction information. The processing includes analyzing the transaction information based on a set of business rules. A database stores previous transaction information and the set of business rules. The processing includes, in response to the analyzing indicating the transaction is fraudulent, generating and adding a flag to the transaction information and storing the transaction information in the database as previous transaction information.

In other features, the transaction information includes at least one of: (i) an amount, (ii) a payor, (iii) a payee, and (iv) a magnetic ink character recognition line. In other features, the set of business rules include: (i) fraud recognition rules and (ii) duplicate detection rules. In other features, analyzing the transaction information based on the set of business rules includes receiving an indication of fraudulent activity from the payment processing device. In other features, the received indication indicates that transaction parameters of the transaction exceed a known fraud threshold.

In other features, the method includes, based on the received indication, cancelling the transaction associated with transaction parameters of the transaction and generating and transmitting a cancellation alert. In other features, the method includes, in response to the transaction being flagged, storing transaction parameters of the transaction in a review database. In other features, the review database is incorporated into the database. In other features, the method includes, in response to the analyzing indicating the transaction is not fraudulent, marking the transaction as safe.

A non-transitory computer-readable medium storing processor-executable instructions, the instructions comprising receiving, from a transaction device, transaction information of a transaction. The transaction information includes at least one of: (i) an amount, (ii) a payor; and (iii) a payee. The instructions include analyzing, using an interactive capture module, the transaction information, transmitting the transaction information to a payment processing module, and processing the transaction information. The processing includes applying a set of business rules to the transaction information and, in response to identifying the transaction information indicates the transaction is fraudulent, generating and adding a flag to the transaction information. The transaction information indicates the transaction is fraudulent based on an analysis by at least one of: (i) a fraud recognition module and (ii) a duplicate detection module. The instructions include storing the transaction information in a database.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings.

FIG. 1 is a functional block diagram of a high-level payment processing system.

FIG. 2 is a functional block diagram of an example implementation of a payment processing system.

FIG. 3 is an example flowchart of processing a payment.

In the drawings, reference numbers may be reused to identify similar and/or identical elements.

### DETAILED DESCRIPTION

A payment processing system provides a single system and method that receives transaction information and analyzes the transaction information according to the same methods. In this way, all transactions or payments are processed using the same payment processing system instead of using unique processing methods for each type of transaction. Not only does using a single processing system and method improve the uniformity of processing, a single processing system, such as the payment processing system of the present disclosure, also processes payments and transactions in real time, ending the need for batch transmissions and processes.

Over the last few years, software vendors and industry analysts have promoted the concept of a payment services hub as the leading approach to modernize financial institution's payment infrastructure. Almost all vendors in the financial payments sector today offer different capture and processing systems, i.e. a separate system for teller capture, mobile capture, back office processing, etc. An enterprise check capture foundation is aimed at eliminating the inherent costs of maintaining different systems for different acquisition channels. By performing the typical back office operations on the capture database, the present disclosure eliminates the need to create, transfer, and process deposits between a deposit originating application and the back office application, that is, the enterprise check capture foundation eliminates the need to capture the same item multiple times. Further, the enterprise check capture foundation eliminates the need to process deposits in a traditional batch-oriented mode.

The payment processing system of the present disclosure enables financial institutions to reduce reliance on file transfers between processing systems, thus resulting in increased security of sensitive information. Therefore, the payment processing system reduces the inherent risk of data in-flight being intercepted when transferring files between systems. Additionally, the payment processing system also reduces the overall infrastructure costs related to file storage. Another advantage of the payment processing system is that this approach provides a smoother transition to introducing newer global payment methods into the same processing system. For each newer payment method, a new plug-in may be introduced that does not require a financial institution to go through a full upgrade of the back office system, resulting in reduced implementation costs. The present architecture approaches to payment processing are unique in the global market as each geography has deployed their own models of processing with little overlap.

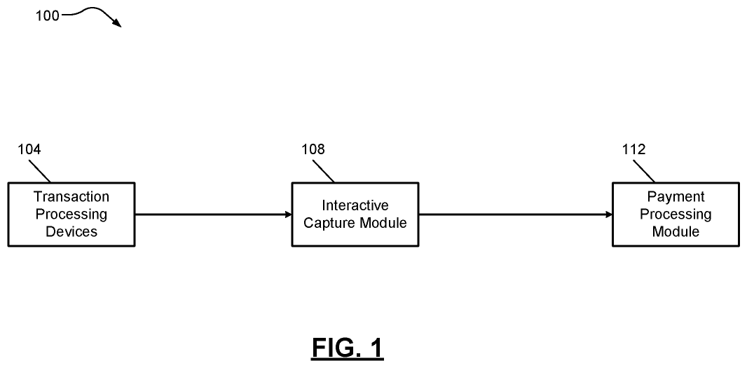

Referring to FIG. 1, a functional block diagram of a high-level payment processing system 100 is shown. The payment processing system 100 includes a plurality of transaction processing devices 104. The transaction processing devices 104 may include mobile computing devices, ATMs, etc., on which financial transactions may be conducted, such as purchasing an item online using a credit or debit card, depositing a check, transferring money, etc. The transaction processing devices 104 transmit transaction information to an interactive capture module 108. The transaction information may include a type of transaction, an amount of money sent or received, a payee, a payor, a date, a magnetic ink character recognition (MICR) line, etc.

The interactive capture module 108 receives the transaction information and interrogates the transaction information. For example, the interactive capture module 108 may parse the transaction information and extract relevant details of the transaction information for future processing by a payment processing module 112. In various implementations, the interactive capture module 108 may analyze the transaction information using a unified analysis method. Additionally or alternatively, the interactive capture module 108 may include a plurality of recognition modules, where each recognition module is configured to analyze transaction information from a corresponding transaction processing device.

Once the interactive capture module 108 has analyzed the transaction information, the payment processing module 112 receives the relevant transaction information for further processing, such as fraud detection and routing to third-party institutions. The interactive capture module 108 receives transaction information in real time, analyzes the transaction information for each individual transaction, and transmits the relevant transaction information to the payment processing module 112, once determined, in real time.

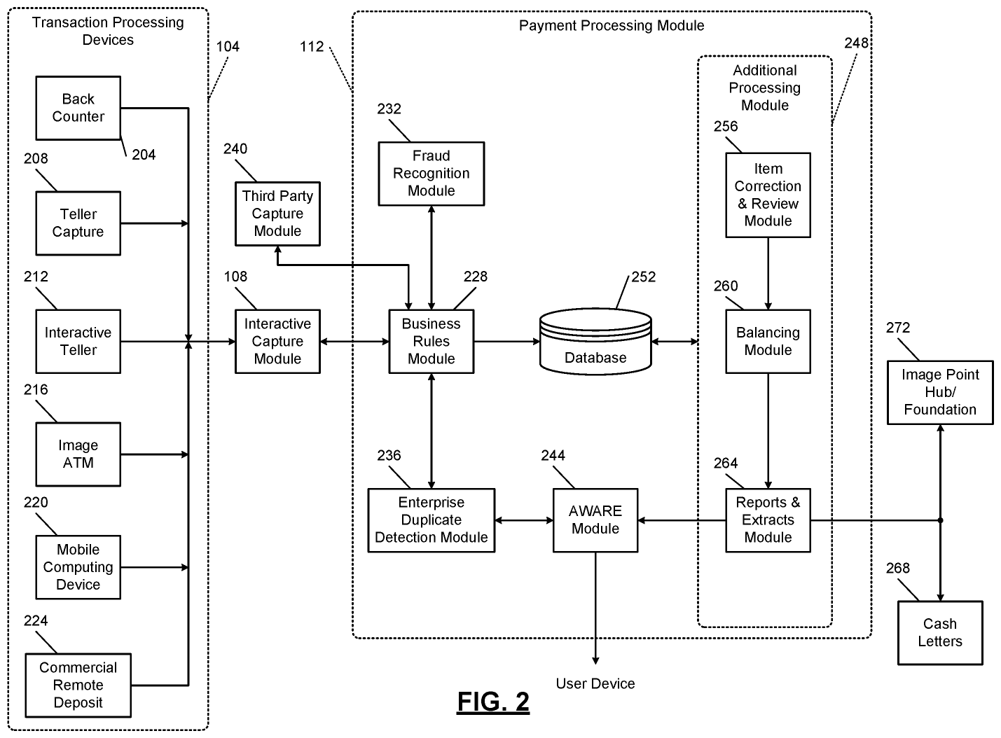

FIG. 2 is a functional block diagram of an example implementation of the payment processing system. The plurality of transaction processing devices 104 include a back counter 204, a teller capture 208, an interactive teller 212, an image ATM, a mobile computing device 220, and a commercial remote deposit 224. The transaction information is transmitted from one of the transaction processing devices 104 to the interactive capture module 108. As discussed above, the interactive capture module 108 analyzes the transaction information and transmits the analyzed transaction information to the payment processing module 112.

The payment processing module 112 includes a business rules module 228 that receives the transaction information from the interactive capture module 108. The business rules module 228 applies a set of business rules to the transaction information. The set of business rules assist in and indicate how to process the transaction information. In various implementations, the business rules module 228 may apply a different set of business rules to the transaction information based on the type of transaction processing device.

The system has a wide variety of business rules. The business rules may include validating that a routing number of a to be deposited check is from a valid US financial institution's routing number and determining whether the check is stale dated or post-dated. Any data element that can be extracted from the image of the check is available for interrogation and subsequent actions can be configured into a business rule.

The business rules module 228 can deliver the transaction information to a fraud recognition module 232, an enterprise duplicate detection module 236, and/or third-party capture module 240. The fraud recognition module 232 may include a set of fraud recognition rules and may compare the set of fraud recognition rules to the transaction information. The fraud recognition module 232 can indicate to the business rules module 228 whether fraud has been detected. Fraud detection is implemented with the help of several third party applications.

The system of the present application sends the front and rear image of the check along with other relevant details like the code line or other parameters required through a web service provided by the third party vendor. The third party application then analyzes the information and passes the results of all tests configured along with the threshold values to an alert or flagging portion of the system. For example, the tests may indicate whether the transaction parameters of a present transaction exceed a known fraudulent threshold, such as transacting with a foreign account, exceeding a transaction limits, etc. Such transactions may be canceled or flagged for human interaction and review.

If the fraud recognition module 232 recognizes that the transaction associated with the transaction information may be fraudulent, the fraud recognition module 232 may instruct the business rules module 228 to flag the transaction. In various implementations, flagging the transaction may include adding a parameter to the transaction information that indicates that the transaction may be fraudulent. Additionally or alternatively, the fraud recognition module 232 may generate and send an alert to the business rules module 228.

The enterprise duplicate detection module 236 detects when the transaction information may be a duplicate. For example, when a check is being deposited, a user may attempt to deposit the exact same check via multiple channels. The enterprise duplicate detection module 236 can identify when the transaction associated with the transaction information is a duplicate and flag the transaction. Additionally, the enterprise duplicate detection module 236 may communicate with an analytics warehouse and reporting engine or AWARE module 244. In various implementations, the AWARE module 244 is a short-term archive of data and images, such as check images, where a user can generate trending reports, conduct data analytics, etc. The AWARE module 244 may receive transaction information including indications of duplicate transactions as well as reports from an additional processing module 248. The AWARE module 244 can access the additional processing module 248 to generate the trending reports and to conduct data analytics and send the reports and/or analytics to a user device. The user device may be the transaction processing device used to perform the transaction or another user device.

The third-party capture module 240 may conduct transactions using a third-party resource, and the transaction information associated with the transaction is directly transmitted from the third-party capture module 240 to the business rules module 228. Once the fraud detection, duplicate detection, and application of the set of business rules is completed, the transaction information may be stored in a database 252. The database 252 is centralized and may include all transaction records.

The additional processing module 248 may access transaction records and transaction information from the database 252. The additional processing module 248 may include an item correction and review module 256, a balancing module 260, and a reports and extracts module 264. Each of the modules included in the additional processing module 248 provide some post-processing functionality. For example, the item correction and review module 256 may access transaction records included in the database 252 and alter any transaction records that the item correction and review module 256 determines is incorrect. Additionally, the balancing module 260 may provide a balancing service for the transactions included in the database 252.

In various implementations, the item correction and review module 256 is a web-based system. An operator can access the results of the item correction and review module 256 through a web browser on their workstation or mobile device, for example, for review of a flagged item. The business rules for analysis may be configured for each institution and determine whether a check image should be sent to the item correction and review module 256. For example, if there are unreadable characters identified in the MICR line, the business rules can be set up to send the image(s) of the item and the code line to the correction module so that it can be verified and cleaned up before the next step in the operation. In addition, an item could be detected as a duplicate suspect of an item captured, for example, a month ago. The same would then be routed to an operator to confirm.

The reports and extracts module 264 may generate reports on the transactions included in the database 252 as well as extract pertinent information to transmit to the AWARE module 244 or transmit additional information to a third-party. For example, the reports and extracts module 264 may extract transaction information and transmit cash letters 268 to a clearing house. In another example, the reports and extracts module 264 may extract and transmit certain transaction information to an image point hub/foundation 272. In various implementations, the reports and extracts module 264 may extract and transmit transaction information or the transaction itself to multiple different third-party institutions to complete transaction processing or for appropriate record retention.

In various implementations, the database 252 may store transaction parameters that have been flagged for review. Then, an entity can access the flagged transactions and review them to see if fraud or duplication is indicated.

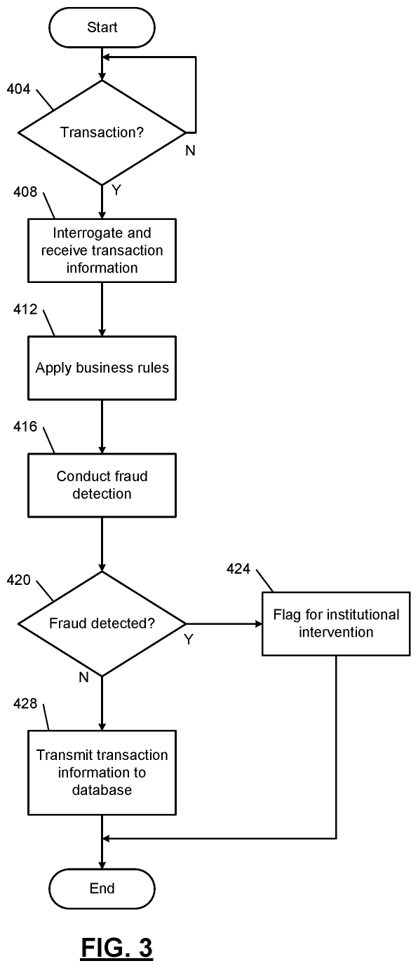

Now referring to FIG. 3, an example flowchart of processing a payment is shown. Control begins at 404, where control determines if a transaction has occurred. If yes control continues to 408; otherwise, control waits for a transaction to occur. At 408, control interrogates and receives transaction information of the transaction. For example, with respect to FIG. 2, the interactive capture module may interrogate and identify transaction information of the transaction. Control continues to 412 and applies a set of business rules to the transaction information. As described above, the set of business rules may be based on a type of transaction device that conducted the transaction.

Once the business rules are applied, control continues to 416 to conduct fraud detection. Fraud detection may include identifying duplicate transactions. At 420, if fraud is detected, control continues to 424 to flag the transaction for intervention by a corresponding financial institution. While the flag may be associated with the transaction from the beginning of the transaction, the financial institution may have a predetermined method for handling potential fraud. In this way, even if a transaction is flagged as potentially fraudulent, the associated financial institution may not intervene until a predetermined time so as to not interrupt any transactions that are not fraudulent. In addition to flagging, control may generate and transmit an alert when fraud is detected. At 424, once the transaction is flagged, control ends. Otherwise, if fraud is not detected at 420, control continues to 428. At 428, control transmits transaction information to a database for storage. The database is a centralized database to allow for centralized processing of transaction information. Using a centralized structure allows for a single system to be used for transaction processing instead of using multiple different systems to process transactions occurring on a plurality of transaction devices.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements.

As used herein, the phrase at least one of A, B, and C should be construed to mean a logical (A OR B OR C), using a non-exclusive logical OR, and should not be construed to mean “at least one of A, at least one of B, and at least one of C.” The term subset does not necessarily require a proper subset. In other words, a first subset of a first set may be coextensive with (equal to) the first set.

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are the BLUETOOTH wireless networking standard from the Bluetooth Special Interest Group and IEEE Standard 802.15.4.

The module may communicate with other modules using the interface circuit(s). Although the module may be depicted in the present disclosure as logically communicating directly with other modules, in various implementations the module may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module may be distributed among multiple modules that are connected via the communications system. For example, multiple modules may implement the same functionality distributed by a load balancing system. In a further example, the functionality of the module may be split between a server (also known as remote, or cloud) module and a client (or, user) module.

Some or all hardware features of a module may be defined using a language for hardware description, such as IEEE Standard 1364-2005 (commonly called “Verilog”) and IEEE Standard 1076-2008 (commonly called “VHDL”). The hardware description language may be used to manufacture and/or program a hardware circuit. In some implementations, some or all features of a module may be defined by a language, such as IEEE 1666-2005 (commonly called “SystemC”), that encompasses both code, as described below, and hardware description.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A system comprising:
at least one processor; and
a memory coupled to the at least one processor,
wherein the memory stores:
a database including previous transaction information and a set of business rules; and
instructions that, upon execution, cause the at least one processor to:
receive, from a transaction device, transaction information of a transaction;
analyze the transaction information; and
transmit the transaction information to a payment processing device to process the transaction information, wherein the processing includes:
analyzing the transaction information based on the set of business rules;
in response to the analyzing indicating the transaction is fraudulent, generating and adding a flag to the transaction information; and
storing the transaction information in the database as previous transaction information.

2. The system of claim 1 wherein the transaction information includes at least one of: (i) an amount, (ii) a payor, (iii) a payee, and (iv) a magnetic ink character recognition line.

3. The system of claim 1 wherein the set of business rules include:
(i) fraud recognition rules and (ii) duplicate detection rules.

4. The system of claim 1 wherein analyzing the transaction information based on the set of business rules includes:
receiving an indication of fraudulent activity from the payment processing device.

5. The system of claim 4 wherein the received indication indicates that transaction parameters of the transaction exceed a known fraud threshold.

6. The system of claim 4 wherein, based on the received indication, the instructions, upon execution, cause the at least one processor to cancel the transaction associated with transaction parameters of the transaction and generate and transmit a cancellation alert.

7. The system of claim 1 wherein the instructions, upon execution, cause the at least one processor to, in response to the transaction being flagged, store transaction parameters of the transaction in a review database.

8. The system of claim 7 wherein the review database is incorporated into the database.

9. The system of claim 7 wherein a device associated with an entity can access the review database to manually review transaction parameters of flagged transactions.

10. The system of claim 1 wherein the instructions, upon execution, cause the processor to, in response to the analyzing indicating the transaction is not fraudulent, marking the transaction as safe.

11. A method comprising:
receiving, from a transaction device, transaction information of a transaction;
analyzing the transaction information; and
transmitting the transaction information to a payment processing device to process the transaction information, wherein the processing includes:
analyzing the transaction information based on a set of business rules, wherein a database stores previous transaction information and the set of business rules;
in response to the analyzing indicating the transaction is fraudulent, generating and adding a flag to the transaction information; and
storing the transaction information in the database as previous transaction information.

12. The method of claim 11 wherein the transaction information includes at least one of: (i) an amount, (ii) a payor, (iii) a payee, and (iv) a magnetic ink character recognition line.

13. The method of claim 11 wherein the set of business rules include:
(i) fraud recognition rules and (ii) duplicate detection rules.

14. The method of claim 11 wherein analyzing the transaction information based on the set of business rules includes:
receiving an indication of fraudulent activity from the payment processing device.

15. The method of claim 14 wherein the received indication indicates that transaction parameters of the transaction exceed a known fraud threshold.

16. The method of claim 14 further comprising, based on the received indication, cancelling the transaction associated with transaction parameters of the transaction and generating and transmitting a cancellation alert.

17. The method of claim 11 further comprising, in response to the transaction being flagged, storing transaction parameters of the transaction in a review database.

18. The method of claim 17 wherein the review database is incorporated into the database.

19. The method of claim 11 further comprising, in response to the analyzing indicating the transaction is not fraudulent, marking the transaction as safe.

20. A non-transitory computer-readable medium storing processor-executable instructions, the instructions comprising:
receiving, from a transaction device, transaction information of a transaction, wherein the transaction information includes at least one of: (i) an amount, (ii) a payor; and (iii) a payee;
analyzing, using an interactive capture module, the transaction information;
transmitting the transaction information to a payment processing module; and
processing the transaction information, wherein the processing includes:
applying a set of business rules to the transaction information;
in response to identifying the transaction information indicates the transaction is fraudulent, generating and adding a flag to the transaction information, wherein the transaction information indicates the transaction is fraudulent based on an analysis by at least one of: (i) a fraud recognition module and (ii) a duplicate detection module; and
storing the transaction information in a database.
